(19) United States
(12) Patent Application Publication
(10) Pub. No.: US 2018/0188639 A1
(43) Pub. Date: Jul. 5, 2018

(54) LIGHT SOURCE APPARATUS IN PROJECTOR

(71) Applicant: HON HAI PRECISION INDUSTRY CO., LTD., New Taipei (TW)

(72) Inventor: SHI-KAI HUANG, New Taipei (TW)

(21) Appl. No.: 15/497,305

(22) Filed: Apr. 26, 2017

(30) Foreign Application Priority Data
Dec. 30, 2016 (TW) 105144031

(51) Int. Cl. G03B 21/20; G02B 27/14; F21V 8/00

(52) U.S. Cl. CPC G03B 21/204; G03B 21/2073; G02B 6/0096; G02B 27/141; G03B 21/2066

(57) ABSTRACT

A reduced-size, high-efficiency projector includes a light source, a dichroic mirror, a quarter-wave sheet, a quarter-wave sheet, and a color wheel. The light source emits a first light ray of a first color which strikes the tilted dichroic mirror. The dichroic mirror reflects the first light ray to generate a second light ray on a second light path. The quarter-wave sheet is arranged on the second light path, and changes a polarization state by about 45 degrees. The color wheel is arranged in front of the quarter-wave sheet and able to generate a third light ray of a second color when irradiated by the first light ray of the first color.

### TECHNICAL FIELD

The subject matter herein generally relates to a light source apparatus in a projector.

### BACKGROUND

Imaging quality of the projectors is important. Generally, a projection system primarily includes a light source device and a projection lens set. Light source efficiency in the light source device can enhance the imaging brightness in the back-end projection lens set, but can lead to a complex and bulky design of the internal structure of the projector, and poor heat dissipation.

### BRIEF DESCRIPTION OF THE DRAWINGS

Implementations of the present technology will now be described, by way of example only, with reference to the attached figures.

FIG. 1 illustrates a schematic view of one exemplary embodiment of a light source apparatus in a projector.

FIG. 2 is a schematic view of one exemplary embodiment of a color wheel of the light source apparatus in a projector shown in FIG. 1.

FIG. 3 is a cross-sectional view of a light combination element of the light source apparatus in a projector shown in FIG. 1.

FIG. 4 is light path of incident light rays through the light combination element shown in FIG. 3.

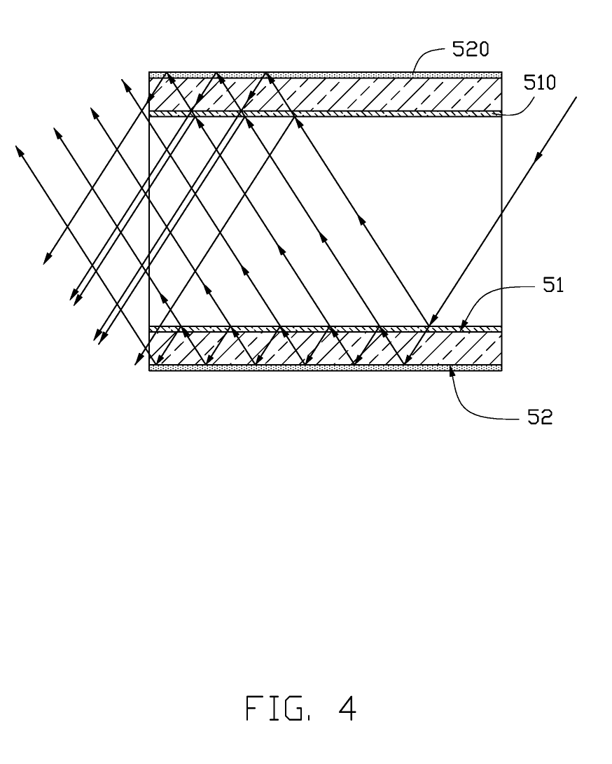

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined as essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

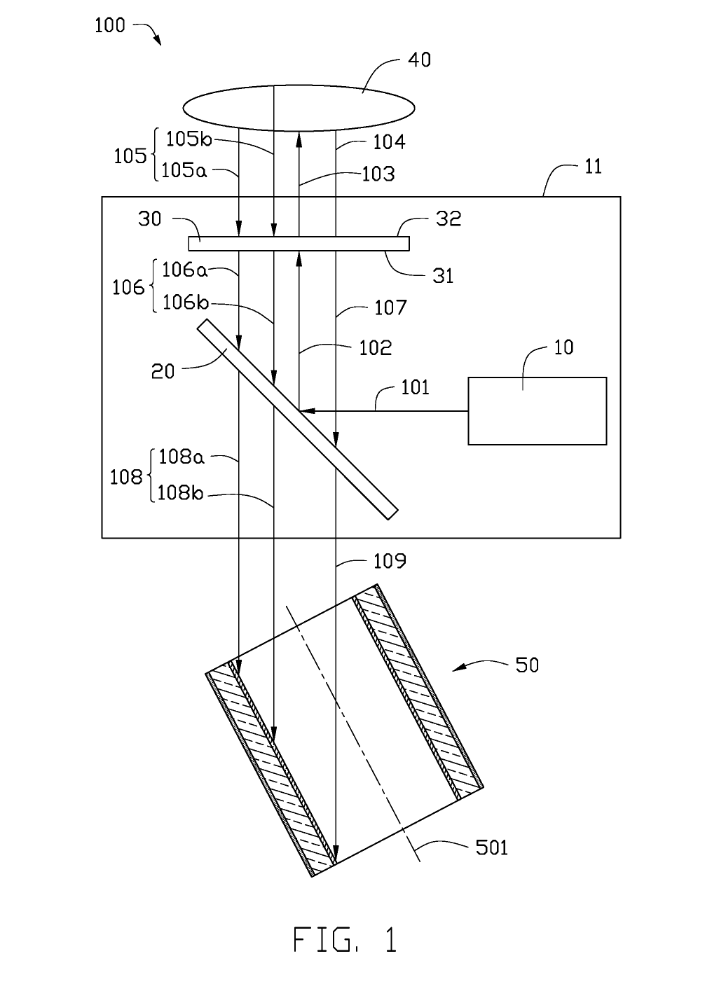

FIG. 1 illustrates a light source apparatus in a projector 100 according to an exemplary embodiment of the present application. The light source apparatus in the projector 100 includes a light source 10, a printed circuit board 11, a dichroic mirror 20, a quarter-wave sheet 30, a color wheel 40, and a light combination element 50.

The light source 10 is mounted on the printed circuit board 11 and configured to emit a first light ray 101 with a first color. The first light ray is a linearly polarized ray and defines a first light path, and the first light path is shown in a horizontal direction from light source 10 of the FIG. 1. In the present exemplary embodiment, the light source 10 is a laser crystal, and emits a blue light ray. The laser crystal is electrically connected with the printed circuit board 11 using Chip-On-Board. A laser crystal reduces the size of the light source apparatus of projector 10.

The dichroic mirror 20 is mounted on the printed circuit board 11 and tilted in relation to the first light path of the first light ray 101. In the present exemplary embodiment, an angle between the dichroic mirror 20 and the first light path of the first light ray 101 is acute and about 45 degrees. The dichroic mirror 20 is configured to reflect the first light ray 101 to generate a second light ray 102, which is along a transmission direction itself. The dichroic mirror 20 is also configured to permit a light ray to be reflected perpendicular to a polarization state of the second light ray 102.

The quarter-wave sheet 30 is mounted on the printed circuit board 11 and arranged on the second light path and in front of the dichroic mirror 20. When a light ray falls on its surface, a polarization state of the light ray is changed about 45 degrees. That is, the quarter-wave sheet 30 includes a first surface 31 and a second surface 32 opposite to the first surface 31. When the second light ray 102 strikes the first surface 31, a polarization state of second light ray 102 is changed about 45 degrees. Further, when a light ray from the color wheel 40 falls on the second surface 32, a polarization state of light ray is also changed about 45 degrees.

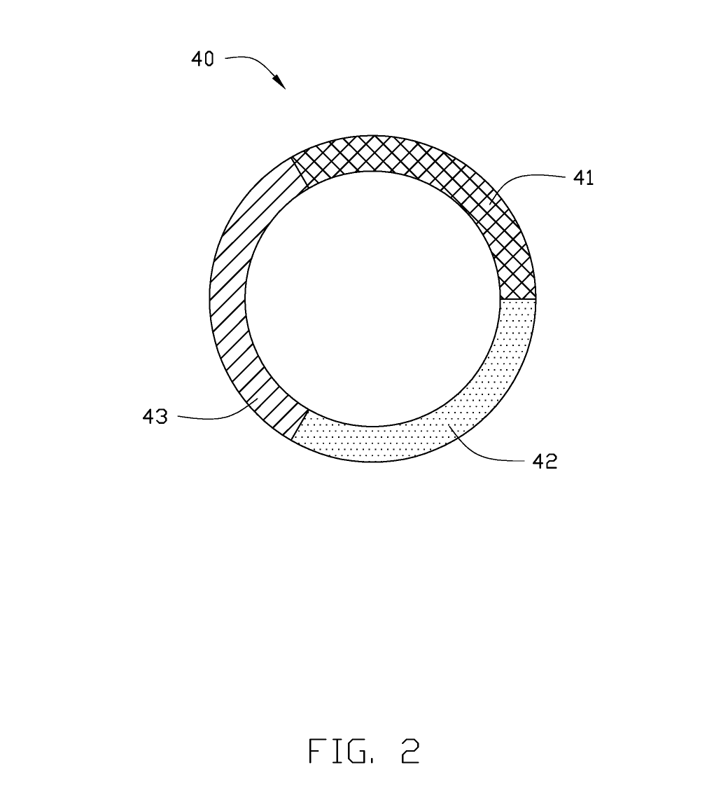

The color wheel 40 is a continuously rotating plate and is able to rotate around its central axis. The color wheel 40 is rotating on a plane that is substantially parallel to the quarter-wave sheet 30. The color wheel 40 is arranged on the second light path and toward the quarter-wave sheet 30. A surface of the color wheel 40 comprises two annular irradiative areas, and the two annular irradiative areas are coated with phosphor layers with different colors. For example, the color wheel 40 includes a first annular irradiative area 41, a second annular irradiative area 42 and a third annular irradiative area 43, as shown in FIG. 2. The first annular irradiative area 41 is coated with a green phosphor layer. The second annular irradiative area 42 is coated with a red phosphor layer. The third annular irradiative area 43 is coated with a reflective layer.

When a light ray irradiates the first annular irradiative area 41, the green phosphor layer is excited and generates a green light ray. When a light ray irradiates the second annular irradiative area 42, the red phosphor layer is excited, to generate a red light ray. When a light ray irradiates the third annular irradiative area 43, the light ray is directly reflected.

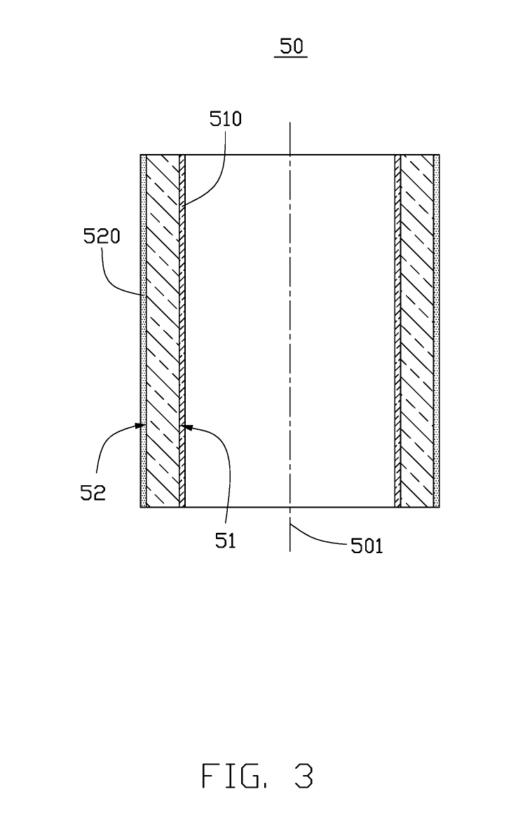

The light combination element 50 is disposed behind the dichroic mirror 20 and configured to merge different light rays which exit from the dichroic mirror 20 and accordingly generate a mixed light. In the exemplary embodiment, as shown in FIG. 3, the light combination element 50 is a hollow light guide tunnel, and includes an inner surface 51 and an outer surface 52. The inner surface 51 is coated with a layer of half reflecting and half transparent film 510, and the outer surface 52 is coated with a layer of reflective film 520. The light combination element 50 includes a center axis 501, and the center axis 501 of the light combination element 50 is tilted relative to light rays exiting from the dichroic mirror 20. Thereby, light rays falling on the inner surface 51 of the light combination element 50 experience reflection and transmission in passing through the light combination element 50.

When light rays fall on the half-reflecting and half-transparent film 510, a portion of the light experiences a reflection, and another portion of the light experiences a transmission. Light rays reaching the reflection film 520 experience a total reflection. The repeated transmissions and reflections in the light combination element 50 increase the number of times that the light rays are refracted and an overall number of light rays, therefore light uniformity is improved.

When the light source apparatus in the projector 100 is in use, the light source 10 emits a first color linearly polarized light 101. The first color linearly polarized light 101 strikes the dichroic mirror 20, the dichroic mirror 20 reflects the first color linearly polarized light 101, and outputs a second light ray 102. The second light ray 102 is perpendicularly incident on the quarter-wave sheet 30, and the quarter-wave sheet 30 changes the polarization state of the light ray 102 by about 45 degrees to generate a third light ray 103. The third light ray 103 is an elliptically polarized ray of light.

In the embodiment, the third light ray 103 is also blue. The third light ray 103 irradiates the color wheel 40, and the color wheel 40 rotates continuously. The color wheel 40 generates a fourth reflected light ray 104 with blue color, and a fifth light ray 105. The fifth light ray 105 includes a light ray 105a with a green color and a light ray 105b with a red color.

When light rays 104, 105 fall on the quarter-wave sheet 30, the polarization state of the light rays 104, 105a and 105b are changed about 45 degrees, and light rays 107, 106a, and 106b are generated, respectively. That is, polarization states of the light rays 107, 106a and 106b are changed about 90 degrees in relation to a polarization state of the light ray 102.

When the light rays 107, 106a, and 106b strike the dichroic mirror 20, the light rays 107, 106a, and 106b penetrate the dichroic mirror 20 and generate light rays 109 with a blue color, 108a with a green color, and 108b with a red color, respectively. The light rays 109, 108a and 108b have different colors, and all of them enter the light combination element 50. The light combination element 50 merges the light rays 109, 108a, and 108b and obtains a mixed light rays. In this way, different color light rays share the same optical channel between the color wheel 40 and the light combination element 50, misalignment of different color rays is avoided, and the size of light source is reduced. Thus, the light source apparatus in projector 100 can project an image on a screen.

The embodiments shown and described above are only examples. Therefore, many details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. A light source apparatus in a projector comprising:
a light source being configured to emit a first light ray of a first color, the first light ray defines a first light path;
a dichroic mirror being tilted relative to the first light path, the dichroic mirror being configured to reflect the first light ray to generate a second light ray, the second light ray defines a second light path;
a quarter-wave sheet being arranged on the second light path, and the quarter-wave sheet being configured to change a polarization state for about 45 degrees when the second light ray incident thereon; and
a color wheel being arranged on the second light path and in front of the quarter-wave sheet, the color wheel being able to generate at least a third light ray of a second color when the second light ray irradiates thereon; and
a light combination element, the light combination element and the quarter-wave sheet are disposed on opposite sides of the dichroic mirror, the light combination element is a hollow light guide tunnel and comprises an opening, and the light combination element comprises a central axis and an inner surface and an outer surface opposite to the inner surface, the inner surface is coated with a half reflecting and half transparent film, and the outer surface is coated with a reflective film, beams emitted from the dichroic mirror are parallel to each other, and the parallel beams are able to intersect with the central axis, all the parallel beams first fall on the inner surface via the opening, and being reflected and refracted by the inner surface, reflected by the outer surface, and then merged by the light combination element to generate a mixed beam.

2. (canceled)

3. The light source apparatus in the projector of claim 1, wherein the light source is a blue laser crystal and configured to emit a blue light ray.

4. The light source apparatus in the projector of claim 1, wherein the color wheel is a continuously rotating plate, and the surface of the color wheel comprises two annular irradiative areas, the two annular irradiative areas being coated with phosphor layers with different colors.

5. The light source apparatus in the projector of claim 4, wherein the two annular irradiative areas are coated with a green phosphor layer and a red phosphor layer, respectively.

6. The light source apparatus in the projector of claim 5, wherein the color wheel comprises a third annular irradiative area being coated with a reflective layer.

7.-8. (canceled)

9. The light source apparatus in the projector of claim 1, further comprising a printed circuit board, wherein the light source is electrically connected with the printed circuit board.

10. The light source apparatus in the projector of claim 1, wherein an acute angle between the dichroic mirror and the first light path is about 45 degrees.

11. A light source apparatus in the projector comprising:
a light source being configured to emit a first color light ray;
a dichroic mirror being tilted on a light path of the first color light ray, and configured to reflect the first color light ray;
a quarter-wave sheet is arranged in front of the dichroic mirror, and the first color light ray from the dichroic mirror is perpendicularly incident on the quarter-wave sheet;
a color wheel facing toward the quarter-wave sheet, the dichroic mirror and the color wheel being arranged on opposite sides the quarter-wave sheet, the color wheel being able to generate at least a second color light ray when the first color light ray irradiates thereon; and
a light combination element, the light combination element and the quarter-wave sheet are disposed on opposite sides of the dichroic mirror, wherein the light combination element is a hollow light guide tunnel and comprises an opening, and wherein the light combination element comprises a central axis and an inner surface and an outer surface opposite to the inner surface, the inner surface is coated with a half reflecting and half transparent film, and the outer surface is coated with a reflective film, beams emitted from the dichroic mirror are parallel to each other, and the parallel beams are able to intersect with the central axis, all the parallel beams first fall on the inner surface via the opening, and being reflected and refracted by the inner surface and reflected by the outer surface, and then merged by the light combination element to generate a mixed beam, wherein the different color light rays share a same optical light path between the color wheel and the light combination element.

12. The light source apparatus in the projector of claim 11, further comprising a printed circuit board, wherein the light source is mounted and electrically connected with the printed circuit board.

13. The light source apparatus in the projector of claim 12, wherein the light source is a blue laser crystal and configured to emit a blue light ray.

14. The light source apparatus in the projector of claim 13, wherein the color wheel is a continuously rotating plate, and a surface of the color wheel comprises two annular irradiative areas, the two annular irradiative areas being coated with phosphor layers with different colors.

15. The light source apparatus in the projector of claim 14, wherein the two annular irradiative areas are coated with a green phosphor layer and a red phosphor layer, respectively.

16. The light source apparatus in the projector of claim 15, wherein the color wheel comprises a third annular irradiative area being coated with a reflective layer.

17.-18. (canceled)

19. The light source apparatus in the projector of claim 11, wherein the light combination element comprises a center axis, and the center axis of the light combination element is tilted relative to light rays exiting from the dichroic mirror.
